(19) United States
(12) Patent Application Publication
(10) Pub. No.: US 2026/0098622 A1
(43) Pub. Date: Apr. 9, 2026

(54) LIGHTING MODULE

(71) Applicant: VALEO VISION, Bobigny (FR)

(72) Inventor: Yves GROMFELD, Bobigny (FR)

(73) Assignee: VALEO VISION, Bobigny (FR)

(21) Appl. No.: 19/112,838

(22) PCT Filed: Sep. 20, 2023
(86) PCT No.: PCT/EP2023/075949

§ 371 Date: Mar. 18, 2025

(30) Foreign Application Priority Data
Sep. 20, 2022 (FR) 2209472

(51) Int. Cl. F21S 41/20; F21S 43/20

(52) U.S. Cl. CPC F21S 41/285; F21S 43/26231

(57) ABSTRACT

The invention relates to a module that produces a beam that contributes to the formation of a low beam, including a light source and a single-piece optical component having an entrance dioptric interface for receiving light rays from the light source, a collimation member for producing a reflection of light rays that are received by the entrance dioptric interface, a folder with a crest line having two cutoff lines that join at an inflection point, and an exit dioptric interface. The collimation member includes a first portion for reflecting a first part of the light rays toward a first zone of the crest line that does not include the inflection point, and a second portion for reflecting a second part of the light rays toward a second zone of the crest line that includes the inflection point.

### TECHNICAL FIELD

The present invention relates to the field of lighting and/or signaling and to the members, optical members in particular, that contribute thereto. It is particularly advantageously applicable to the field of automotive vehicles. In particular, it relates to a luminous module and to a luminous device incorporating a plurality of such modules. An aim is the formation of a beam of the low-beam type that is capable of being equipped to the front of an automotive vehicle.

### BACKGROUND OF THE INVENTION

In the automotive sector, devices capable of emitting light beams that perform or contribute to the performance of lighting and/or signaling functions are known.

These devices have to meet the applicable regulations by emitting light at the desired locations while limiting the brightness in certain zones.

Thus, lighting modules or headlamps are known, among which there are conventionally low beams, with a range on the road in the region of 70 meters, which are used mainly at night and of which the distribution of the light beam is such that it makes it possible to not dazzle the driver of an oncoming vehicle. Typically, this beam has a cutoff in the upper part with a horizontal portion, preferably approximately 0.57 degrees below the horizon, in order to not illuminate the zone in which the driver of a vehicle arriving in the opposite direction ought to be located, and an angled portion.

The precise definition of the angled shape, also called “kink”, has already been given in the prior art, for example in patent publication FR 3010772 A1. In that document, a dioptric component is used to create a portion of a low beam, and in particular the cutoff part of the low beam. From an entrance surface, the rays are subjected to internal reflection in the dioptric component and are projected through an exit dioptric interface. However, beforehand, the beam is subjected to shaping by way of a folder, in practice in the form of a trench whose crest line has a profile representative of the desired cutoff. The light rays which strike the folder below the crest line are reflected, so as to avoid forming an upward projection, as a “high”beam would.

The benefit of this dioptric component offering a compact and less complex solution for forming part of a beam is understood. However, this part has to be complemented by at least one other beam part produced by another module. In particular, once the first module produces a cutoff portion, at the very least one other module has to be implemented to produce a portion, which is wider and relatively flat horizontally, of the final low beam. In addition to the multitude of different modules that this requires, the appearance of the overall luminous device is not homogeneous in the turned-on state. Specifically, when moving away from the optical axis, the illuminated appearance of the module producing the kink in the cutoff differs from that of the module producing the flat beam.

An object of the present invention is therefore to propose a luminous module and a device that make it possible to at least partially overcome the cited drawbacks.

The other objects, features and advantages of the present invention will become apparent upon studying the following description and the accompanying drawings. It will be understood that other advantages may be incorporated.

### SUMMARY OF THE INVENTION

To achieve this objective, according to one embodiment, what is provided is a luminous module for producing a beam configured to contribute to the formation of a low beam, comprising a light source capable of emitting light rays, and a single-piece optical component having:
an entrance dioptric interface intended to receive light rays from the light source,
a collimation member configured to produce a reflection, within the optical component, of light rays that are received by the entrance dioptric interface,
a folder comprising a crest line having two cutoff lines that join at an inflection point, and
an exit dioptric interface through which the beam is projected,
characterized in that the collimation member comprises a first portion configured to reflect a first part of the light rays toward a first zone of the crest line that does not comprise the inflection point, and a second portion configured to reflect a second part of the light rays toward a second zone of the crest line that is separate from the first zone and comprising the inflection point.

Thus, the luminous module is capable of producing several parts of the full shape of the low beam, and in particular both a part providing the kink shape and a wider part that generally extends to a zone nearer to the vehicle.

Preferably, the entirety of the envelope of the low beam is covered by the beam projected by a module. Thus, each module has functional independence. While it is possible to think that a given optical component is solely intended to produce a single beam shape, what is produced in this case is a module whose optical component comprises several portions, each intended for a beam shape to be projected.

In particular, the first portion of the collimation member may form a first sub-beam which provides the width to the overall beam projected, for example of the flat or beam of width type, in the sense that the light is preferably mainly spread horizontally, this not ruling out that the upper edge of the beam is not entirely horizontal as described in detail below. The second portion may make it possible to form a second sub-beam focused on the change of direction of the kink, corresponding to the kink zone of the low beam. Potentially, other rays originating from the light source may supplement these two sub-beams; in particular, the second sub-beam may be reinforced by light propagating directly in the optical component from a zone of the entrance dioptric interface to the inflection point.

In an optional embodiment, one and/or the other of the first and second portions are produced as several sectors that are separate from one another. This makes it possible to benefit from a large reflection surface and to spatially diversify the reflection zones contributing to the same part of the beam. For example, different sectors are used to contribute to the first sub-beam and/or different sectors are used to contribute to the second sub-beam.

Another aspect relates to a luminous device comprising a plurality of luminous modules. Even if it is not ruled out that a single luminous module produces the entire low beam, by combining several modules, it is possible to easily adjust the overall luminous power that has to be achieved for the “low-beam” function. By configuring the various modules such that their projections are superposed toward the front of the vehicle, their effects stack up to achieve the desired illumination.

Furthermore, if these various modules are identical, including preferably in terms of luminous power, the visual appearance that they produce in the turned-on state does not differ from one module to another for an observer outside the vehicle. This is esthetically homogeneous. For example, the modules may be superposed.

Another aspect also relates to a vehicle equipped with at least one module and/or with at least one luminous device.

### BRIEF DESCRIPTION OF DRAWINGS

Aims, objects, features and advantages of the invention will become more clearly apparent from the detailed description of one embodiment of the invention, which embodiment is illustrated by the following accompanying drawings, in which:

FIG. 1 shows one embodiment of a module in perspective.

FIG. 2 shows an example of superposition of modules to form a luminous device.

FIG. 3a shows a perspective view of relevant surfaces in a module.

FIG. 3b illustrates a light projection originating from a luminous module producing a beam of a shape corresponding to a low beam.

FIG. 4a shows elements of the luminous module that contribute to forming part of the beam.

FIG. 4b illustrates a light projection originating from the luminous module by virtue of the elements presented in the preceding figure.

FIG. 5a shows elements of the luminous module that contribute to forming part of the beam.

FIG. 5b illustrates a light projection originating from the luminous module by virtue of the elements presented in the preceding figure.

FIG. 6a shows elements of the luminous module that contribute to forming part of the beam.

FIG. 6b illustrates a light projection originating from the luminous module by virtue of the elements presented in the preceding figure.

FIG. 7a shows elements of the luminous module that contribute to forming part of the beam.

FIG. 7b illustrates a light projection originating from the luminous module by virtue of the elements presented in the preceding figure.

FIG. 8 shows another shape of certain surfaces of the module, in particular with a folder of curved shape.

FIG. 9 shows a perspective view of relevant surfaces in a module according to an embodiment variant.

The drawings are provided by way of example and do not limit the invention. They are schematic conceptual depictions intended to facilitate understanding of the invention and are not necessarily drawn to the scale of practical applications.

### DETAILED DESCRIPTION OF THE INVENTION

Before starting a detailed review of embodiments of the invention, optional features that may possibly be used in combination or alternatively will be outlined below:
the first portion and/or the second portion comprises a plurality of sectors that are spaced apart from one another;
the plurality of sectors of the first portion comprises two lateral sectors 42 that are disposed on either side of a central sector 41 of the collimation member 4;
the two lateral sectors 42 and the central sector 41 are disposed on a surface of the collimation member 4 that is situated above an optical axis of the optical component 1;
the second portion comprises the central sector 41; it is preferably constituted by this central sector 41;
the collimation member 4 comprises a complementary sector 43 configured to reflect a third part of the light rays toward the entire crest line;
the entrance dioptric interface 3 comprises a central portion 31 configured to transmit light rays toward the second zone of the crest line;
in a direction of the optical axis of the optical component 1, the distance separating the folder 5 and the exit dioptric interface 6 is equal to the focal distance of the exit dioptric interface 6;
the inflection point 53 is situated on the optical axis of the optical component 1;
at least one of the two cutoff lines 51, 52 is curvilinear;
the light source is configured to emit the light rays along the optical axis of the optical component 1, the entrance dioptric interface 3, the collimation member 4 and the exit dioptric interface 6 being aligned along the optical axis;
the light source is configured to emit the light rays along an axis transverse to the optical axis of the optical component 1, the entrance dioptric interface 3 and the collimation member 4 being disposed along the transverse axis, and the optical component 1 having a reflective surface 7 disposed between the collimation member 4 and the folder 5 and configured to receive the light rays that are reflected by the collimation member 4 and to reflect them along the optical axis of the optical component 1 toward the folder 5.

The invention also relates to a luminous device comprising a plurality of modules such as described above;

Preferably, at least some of the modules of the plurality of modules are superposed; this superposition is advantageously effected along the vertical, that is to say preferably a perpendicular to the optical axis and to the horizontal;
the superposed modules advantageously have an offset in a direction of the optical axis, preferably forming a rectilinear slope.

It is specified that within the context of the present invention, the term “kink or kinked” means that the luminous projection has an upper cutoff having a substantially flat portion and an oblique portion, the two portions forming between them an angle of between 15° and 45°.

With respect to the features set out below, terms relating to verticality, horizontality or transversality (or even the lateral direction), or equivalents thereof, are to be understood with respect to the position in which the module is intended to be fitted in a vehicle. The terms “vertical” and “horizontal” are used in the present description to denote, regarding the term “vertical”, a direction with an orientation perpendicular to the plane of the horizon (which corresponds to the height of the systems), and, regarding the term “horizontal”, a direction with an orientation parallel to the plane of the horizon. They are to be considered under the conditions of operation of the device in a vehicle. The use of these words does not mean that slight variations about the vertical and horizontal directions are excluded from the invention. For example, an inclination relative to these directions of the order of + or −10° is here considered to be a minor variation about the two preferred directions. With respect to the horizontal plane, the inclination is in principle between −5° and 4°, and it is between −6° and 7.5° laterally. Furthermore, the adjectives “lower” and “upper” are to be considered in relation to the vertical direction; in the same context, an upper element will be situated above (but not necessarily in contact or directly in line with) a lower element, in the vertical direction.

The luminous module proposed here makes it possible to produce a first sub-beam and a second sub-beam that correspond to light projections of different shapes, but that supplement each other to produce a projected beam having the spatial configuration of a beam of the low-beam type. According to one option, the luminous module is configured to perform, on its own, the low-beam function, and may potentially be combined with other luminous modules according to the invention in order to increase the luminous power, it being understood that with the increase in the luminous power, the low-beam function remains statutory.

According to another option, the luminous module is configured to produce the luminous distribution of the low-beam function, but at a lower power level than that demanded by the regulations. The luminous module is then combined with one or more other luminous modules according to the invention to achieve the luminous power level necessary for the low-beam function. Preferably, all of the modules are identical.

The first luminous sub-beam produced by the module may be a beam of width. It is projected overall below the cutoff of the low beam and serves to illuminate the field near to the front of the vehicle. A near-field beam of a low beam is typically a projection that is relatively spread out laterally to the front of the vehicle, predominantly or completely below with the horizon line, generally seeking good distribution of the illumination over the entire illuminated zone.

The second luminous sub-beam may define a kinked zone. Thus, the combination of the first luminous sub-beam and of the second luminous sub-beam defines at least one beam of the low-beam type, potentially except in terms of the provided luminous power.

Beams of the low-beam type typically have a first lateral zone (normally at the edge of the roadway) that projects at a slightly higher height than in a second lateral zone (normally at the center of the roadway), these two zones following one another laterally with the presence of a turn or bend between them.

Such a module comprises a light source, preferably a unitary light source; this may be a light-emitting diode, the mean axis of emission of which is disposed on the optical axis of the optical component of the module. By way of example, the power of the source may be 300 lm.

The collimation member 4 comprises a first portion configured to reflect a first part of the light rays toward a first zone of the crest line that does not comprise the inflection point 53. This first zone is advantageously divided into two elementary zones situated on either side of the inflection point 53, without comprising the latter. Each of these two elementary zones may be borne by a first line 51 and a second line 52 of the crest line. In addition, the second portion of the collimation member is configured to reflect a second part of the light rays toward a second zone of the crest line that is separate from the first zone and comprises the inflection point 53. This separation means that there are no common points between the first zone and the second zone.

According to one possibility, the second zone comprises only the physical location of the inflection point. The width of the second zone, extending perpendicularly to the optical axis in a horizontal direction, may therefore be very small. However, it may be wider and extend on either side of the inflection point 53 on the first line 51 and the second line 52.

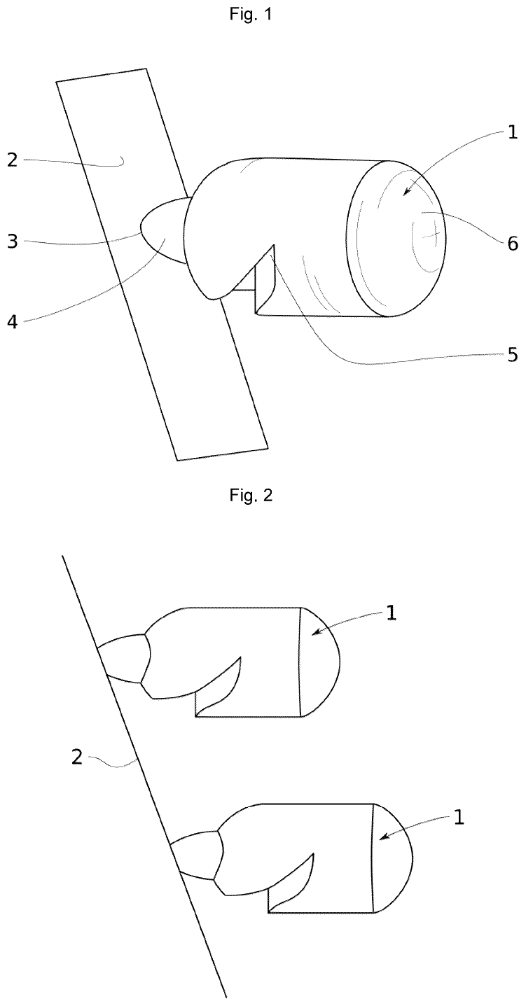

FIG. 1 gives one exemplary embodiment of the module. Said module primarily comprises an optical component 1 which extends in a direction of the optical axis from an entrance dioptric interface 3 to an exit dioptric interface 6. The light is received by the entrance dioptric interface 3 from a light source, which is preferably disposed on a support 2, for example of the printed circuit board type. Along the path of the light admitted into the optical component, a collimation member 4 and a folder 5 successively intercept the light rays originating from the source.

In this exemplary embodiment, the light source emits light rays along the optical axis of the optical component 1, and the entrance dioptric interface 3, the collimation member 4 and the exit dioptric interface 6 are aligned along the optical axis.

Preferably, the light rays originating from the source are not processed in any other way than by the optical component 1; the beam is therefore advantageously produced completely by virtue of this single element. The optical component 1 is in one piece and is preferably made of a single material. This may be polymethyl methacrylate (PMMA) or polycarbonate. For example, its shape may result from a molding method.

FIG. 2 reflects the possibility of combining a plurality of luminous modules 1. Thus, in the vertical direction, modules follow one another in this example with optical axes that are parallel and advantageously coplanar. Furthermore, this figure presents an additional option in which the modules 1 are offset in the direction of the optical axis so as to arrange them along a slope. Potentially, the sources of the various modules may be borne by the same support 2. The inclination of the latter in FIG. 2 reflects the slope defined by the superposition of modules 1. This slope is formed at an angle greater than 5° and/or less than 15° relative to a vertical line. In this example, the modules are all the more remote from the front end of the vehicle as they are situated high up.

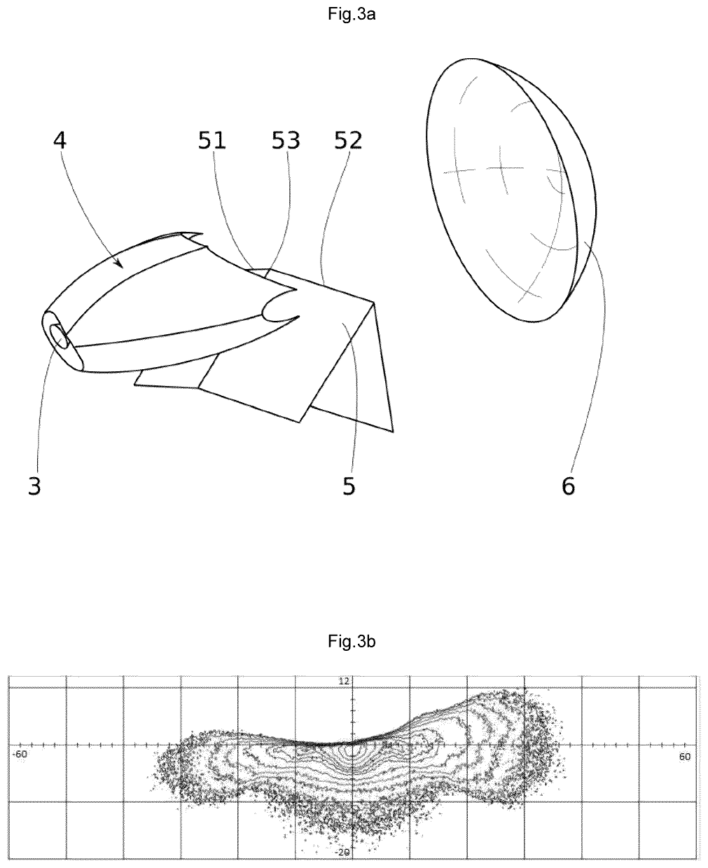

FIG. 3a is a schematic depiction of relevant surfaces for the processing of the light, within the optical component 1. It is recalled that this component is in one piece, so the schematic distinction of the surfaces illustrated in FIG. 3a should be understood to be a partial depiction of certain elements, and in particular of certain surfaces of the outer envelope of the component 1.

Found therein is the entrance dioptric interface 3, preferably centered on the optical axis of the module, the dioptric interface 3 serves to admit light rays originating from the source placed upstream (not shown in the figure). In the direction of the exit dioptric interface 6, a collimation member 4 makes it possible, for part of the light rays, to produce a reflection. Said reflection is advantageously of the total internal reflection type; thus, the surfaces of the collimation member 4 have angles that are configured to enable this internal reflection, thus preferably avoiding the placement of a reflective surface on the collimation member 4.

FIG. 3a also schematically shows the folder 5 which is provided with a first line 51 and with a second line 52 at its crest, the lines 51, 52 joining at an inflection point 53. The inflection point 53 is preferably situated on the optical axis. It will be appreciated that the folder 5 shapes the light so as to produce a cutoff whose line is defined by the first line 51 and the second line 52. As seen above, in order to produce a kinked shape characteristic of a low beam, an angle is present between the first line and the second line, at the inflection point 53.

FIG. 3b provides an example of an isocandela curve representative of a projection produced by the luminous module thus proposed. The flat nature of the beam on the cutoff line is clearly distinguished, with a concentration of intensity in the vicinity of the optical axis. Substantially at this level too, the effect of the cutoff is noted with part of the beam projecting lower on the left than on the right, and this is typical of a projection for a right-hand-drive vehicle.

A description will be given below of different parts of the module that each make it possible to produce different parts of the full beam presented in FIG. 3b.

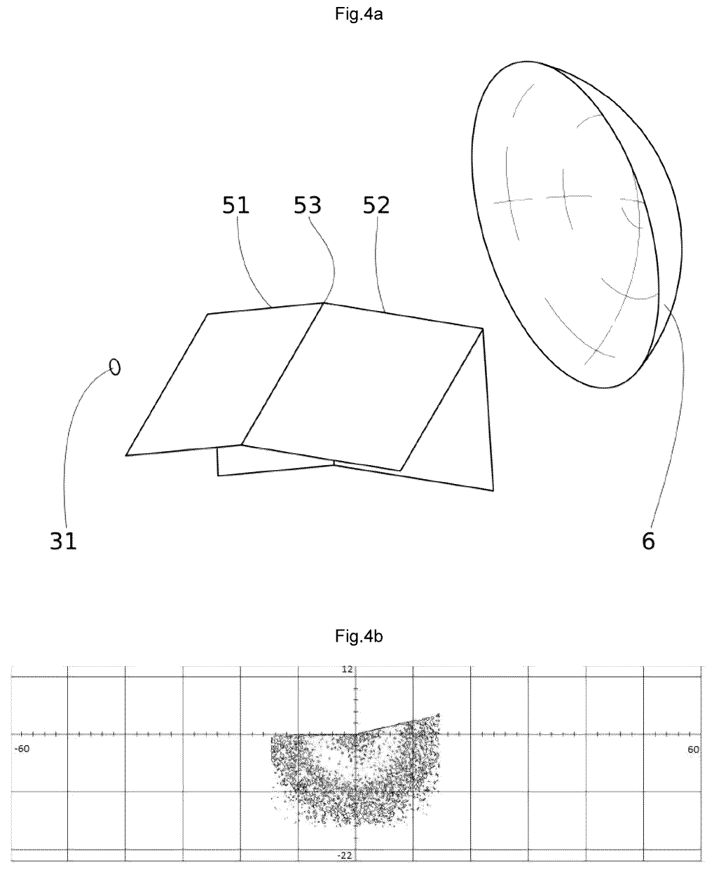

Thus, FIG. 4a presents means that contribute to providing at least part of the kinked zone of the beam. A central portion 31 of the entrance dioptric interface 3, typically a circular zone centered on the optical axis, admits light from the source and returns it in a focused manner at the inflection point 53 of the folder 5. The light is therefore concentrated around the inflection point and makes it possible to precisely define the kinked zone. A depiction of this beam part that is projected through the exit dioptric interface 6 is reflected in FIG. 4b.

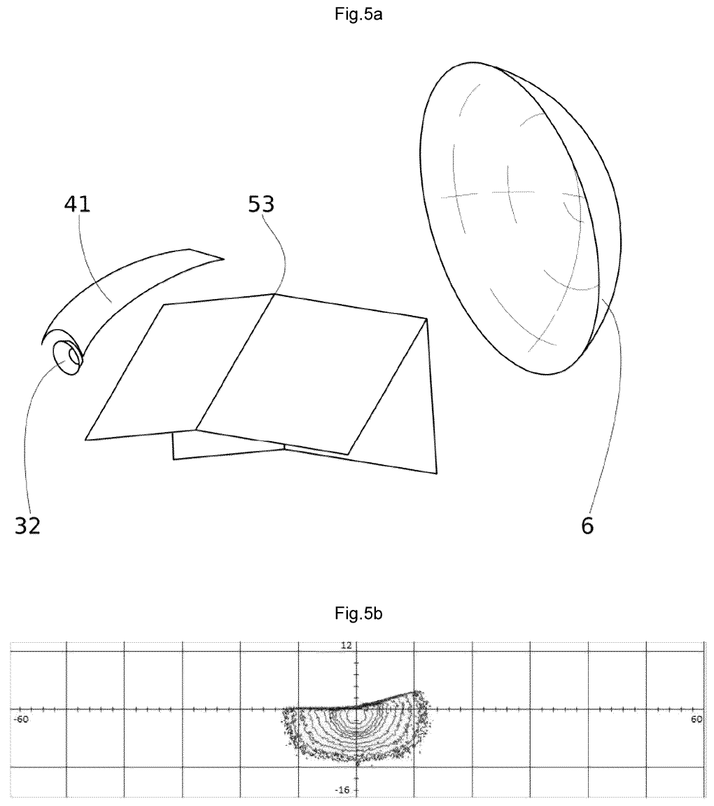

The collimation member 4 itself also makes it possible to provide a portion of light rays that serve to define the second sub-beam, that is to say the beam defining the kinked portion of the low beam. FIG. 5a presents surfaces that are relevant for this purpose: a second portion of the entrance dioptric interface 3, typically a peripheral portion 32 disposed around the aforementioned central portion 31, receives some light rays from the source. Part of the rays thus admitted into the optical component 1 pass as far as the central sector 41 of the collimation member 4 where they are subjected to reflection in the direction of the folder 5, toward the inflection point 53. As seen above with reference to FIG. 4a, this makes it possible to shape this beam part to obtain the result in FIG. 5b. It will be appreciated that the means presented with reference to FIG. 5a and those described with reference to FIG. 4a allow their effects to stack up to achieve a desired level of luminous intensity for this part of the final beam.

Preferably, the sector 41 is disposed in an upper half-plane of the optical component 1, this meaning a part of the latter that is situated above the optical axis in a normal position of use of the module, on the opposite side from the folder 5. Also, preferably, the sector 41 intercepts a vertical plane passing through the optical axis. Preferably, the sector 41 is symmetrical relative to this plane. For example, the sector 41 may extend over an angular sector greater than 10° and/or less than 30° around the entrance dioptric interface 3. The shape of the surface of the collimation member 4 defining this sector 41 is selected so as to produce collimation in the direction of the inflection point 53. According to one possibility, the profile of the sector 41 along the vertical plane passing through the optical axis may be of the elliptical type with a focal line around the inflection point 53 or a parabola focus in the region of the inflection point 53.

The light projected by the luminous module is supplemented by another, flatter sub-beam, typically making it possible to produce the extended shape in terms of width of a low beam.

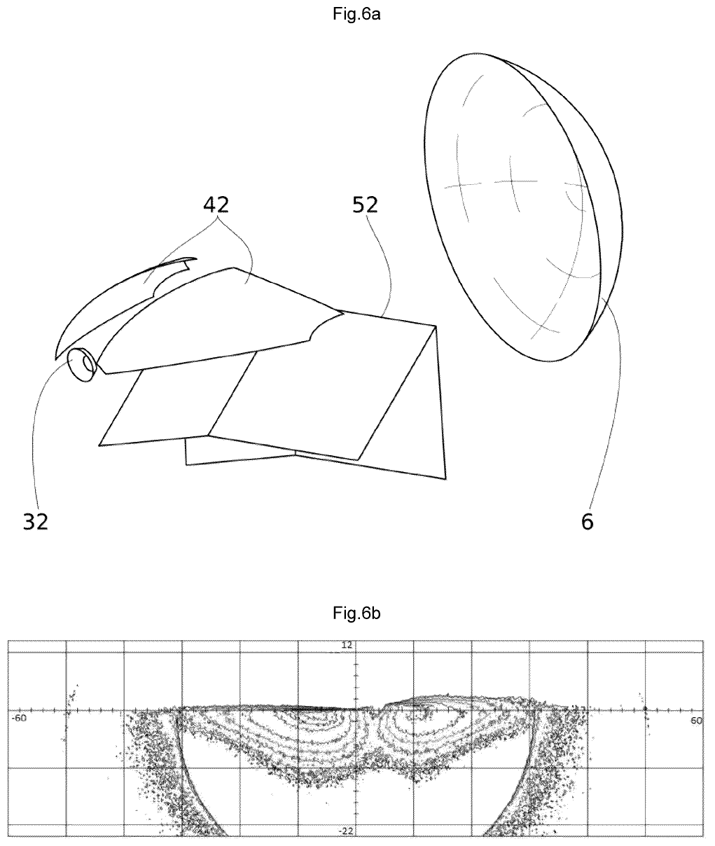

To this end, FIG. 6a shows that the collimation member 4 may comprise two sectors 42 disposed around the central sector 41 described above. These sectors 42 receive light from the peripheral portion 32 of the entrance dioptric interface 3 and are configured to reflect it toward the lines 51, 52 of the folder 5. As above, these sectors may be given an elliptical shape in order to produce a reflection toward a focal line situated on the lines 51, 52. Preferably, the sectors 42 are symmetrical around the vertical plane passing through the optical axis. Preferably, they are contiguous with the central sector 41. A first lateral sector 42 directs the light toward the first line 51, whereas a second lateral sector 42 directs the light toward the second line 52; this reflection is effected without affecting a central zone of the cutoff line, around the inflection point 53, taking account of the configuration of the sectors that are situated around the central sector 41.

FIG. 6b provides an example of a light portion projected via the corresponding exit dioptric interface 6. The complementary nature of the light emitted by this portion of the collimation member 4 and of the light emitted by the preceding portion (typically the central sector 41) of this member 4 is noted. The luminous projection visible in FIG. 6b is spread out laterally. It has an upper edge which has a horizontal left part which may correspond to the upper edge of the overall beam (low beam) at this level. The right part is not necessarily horizontal and, in this case, it is inclined, meaning that this part is at least partially covered by the complementary projection forming the kinked portion, raising the beam upward.

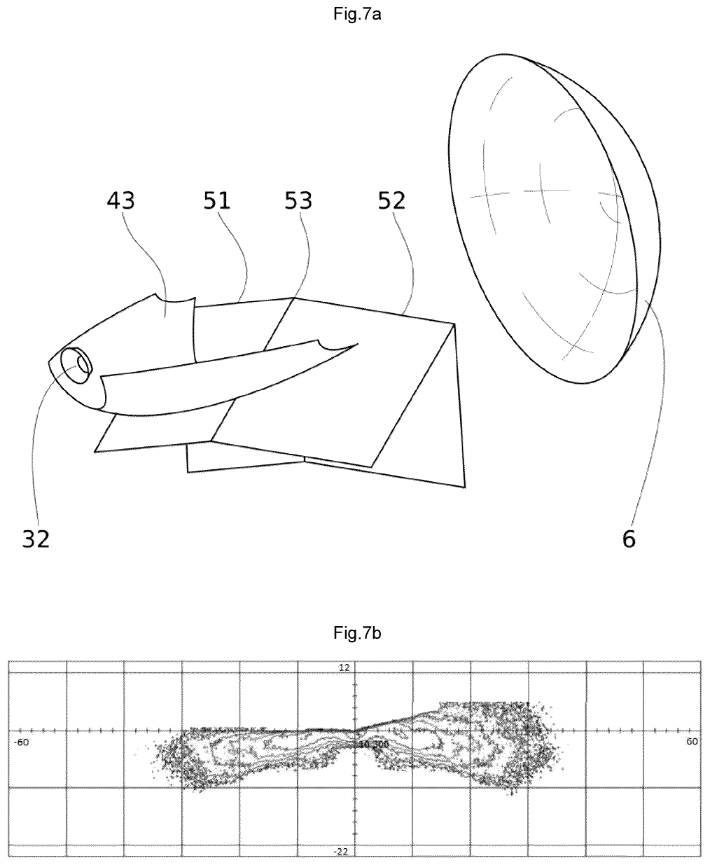

According to one possibility, these two portions are supplemented by light that is reflected by another sector of the collimation member 4. This is reflected in FIG. 7a, in which a complementary sector 43 of the surface of the collimation member 4 is disposed facing the sectors 41, 42 relative to a horizontal plane passing through the optical axis. The sector 43 is therefore situated in a lower half-plane of the optical component 1. Preferably, the sector 43 covers an angular sector of 180° around the entrance dioptric interface 3. Preferably, the angular sectors covered by the central sector 41, the lateral sectors 42 and the complementary sector 43 sweep the entire perimeter of the entrance dioptric interface 3, thus forming a surface of 360° around the latter.

The sector 43 is configured to reflect light rays originating from the peripheral portion 32 of the entrance dioptric interface 3 toward the first and the second line 51, 52 of the folder 5. As above, it is possible to use a suitable shape for the sector 43 so as to form a focal line situated at this location for the reflection, and notably a parabolic shape.

FIG. 7b provides an example of a light portion corresponding to the contribution of the sector 43. Taking account of the angular sector that it sweeps, the sector 43 affects the entire width of the folder 5, so the resultant beam part contributes both to the kinked zone around the inflection point 53 but also to the width of the beam, including in its flat part.

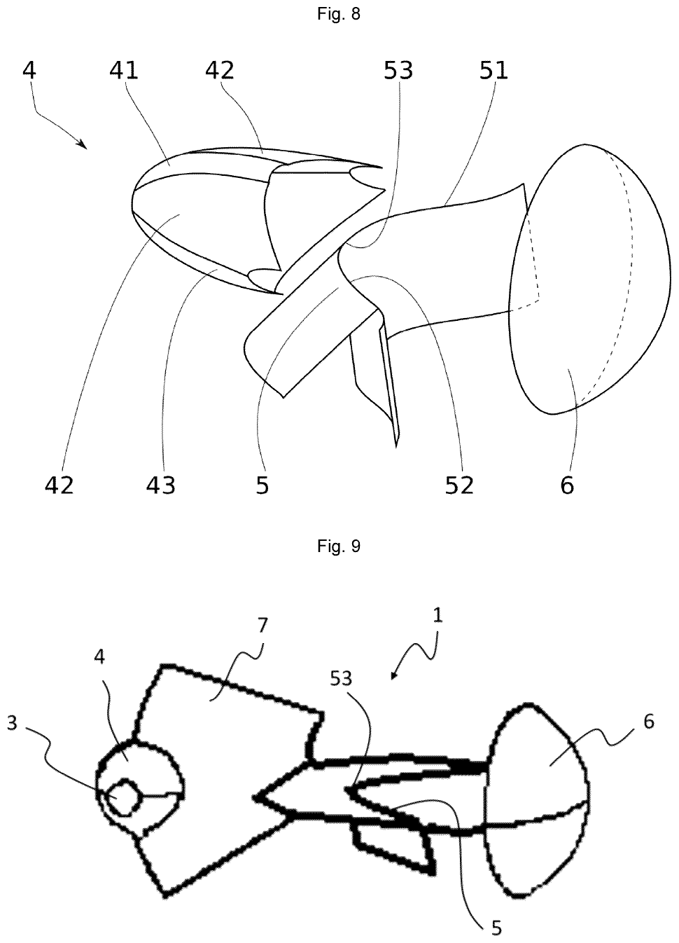

FIG. 8 outlines an embodiment variant of the functional surfaces of the optical component 1. More particularly, this variation relates to the folder 5, the principle of the collimation member 4 with different portions remaining identical to the explanations above. According to this arrangement, the folder 5 is curved and this curvature compensates for curvature of field aberrations of the exit dioptric interface 6. More specifically, from the inflection point 53, the curvature of the folder 5 follows a profile of the crest line with the first line 51 and the second line 52 extending curvilinearly with a convexity oriented toward the collimation member 4.

In general, it is advantageous for the exit dioptric interface 6 to be focused on the folder 5. Also, the focal distance of the exit dioptric interface 6 advantageously corresponds to the distance between the folder 5 and the exit dioptric interface 6 measured at the optical axis.

FIG. 9 illustrates an embodiment variant of a luminous module according to the invention. In this figure, only the optical surfaces of the module are shown. This exemplary embodiment differs from the one illustrated in FIGS. 1 and 8 solely in that the light source emits light rays along an axis transverse to the optical axis of the optical component, and in that the optical component 1 has a reflective surface 7 disposed between the collimation member 4 and the folder 5.

The entrance dioptric interface 3 and the collimation member 4 are disposed along this transverse axis. The reflective surface 7 receives the light rays are reflected by the collimation member 4 and reflects them along the optical axis of the optical component 1, toward the folder 5. It will be noted that in this example, the optical axis of the optical component 1 is defined by the optical axis of the exit dioptric interface 6. It will be noted that, as for the exemplary embodiment in FIG. 1, the optical axis of the optical component 1 extends in a longitudinal direction when the module is positioned in a vehicle, in its normal mounting position.

It will be appreciated that in this exemplary embodiment, by way of the reflective surface 7, the collimation member 4 readily makes it possible to reflect a first part of the light rays toward a first zone of the crest line that does not comprise the inflection point 53, and a second part of the light rays toward a second zone of the crest line that is separate from the first zone and comprises the inflection point 53. Specifically, the collimation member 4 may direct the first part of the light rays toward the reflective surface 7, which can in turn direct this first part of the light rays toward a first zone of the crest line that does not comprise the inflection point 53. And the collimation member 4 may direct the second part of the light rays toward the reflective surface 7, which can in turn direct this second part of the light rays toward a second zone of the crest line that is separate from the first zone and comprises the inflection point 53.

As described above, it is possible to combine a plurality of luminous modules 1, and in particular several luminous modules as illustrated in FIG. 9 in order to form a luminous device. The emission of light rays in a direction transverse to the optical axis of the optical component 1 by the light source, and the orientation in this transverse direction of the entrance dioptric interface 3 and of the collimation member 4, then makes it possible to facilitate the formation of all the luminous modules of the luminous device as a single component. In other words, this arrangement of the entrance dioptric interface 3 and of the collimation member 4 of the luminous modules makes it possible to more easily form a single-piece luminous device. In particular, this arrangement makes it possible to facilitate the injection molding and the demolding of the single-piece optical device.

Non-limitingly, examples of satisfactory dimensioning are given below:
use of a light source in the form of an LED with a surface area of 1 mm² and focal distance of 25 mm;
alternatively, use of a light source in the form of an LED with a surface area of 2 mm² and focal distance of 50 mm.

The focal distances indicated above can tolerate a variation of plus or minus 40% around the indicated value, and preferably of plus or minus 20%.

The invention is not limited to the embodiments described above.

### LIST OF REFERENCES

1. Optical component
2. Support
3. Entrance dioptric interface
31. Central gate
32. Peripheral portion
4. Collimation member
41. Central sector
42. Lateral sector
43. Complementary sector
5. Folder
51. First line
52. Second line
53. Inflection point

What is claimed is:

1. A luminous module for producing a beam configured to contribute to the formation of a low beam, comprising a light source capable of emitting light rays, and a single-piece optical component having:
an entrance dioptric interface intended to receive light rays from the light source,
a collimation member configured to produce a reflection, within the optical component, of light rays that are received by the entrance dioptric interface,
a folder including a crest line having two cutoff lines that join at an inflection point, and
an exit dioptric interface through which the beam is projected,
wherein the collimation member includes a first portion configured to reflect a first part of the light rays toward a first zone of the crest line that does not includes the inflection point, and a second portion configured to reflect a second part of the light rays toward a second zone of the crest line that is separate from the first zone and includes the inflection point.

2. The module as claimed in claim 1, wherein the first portion and/or the second portion includes a plurality of sectors that are spaced apart from one another.

3. The module as claimed in claim 2, wherein the plurality of sectors of the first portion includes two lateral sectors that are disposed on either side of a central sector of the collimation member.

4. The module as claimed in claim 3, wherein the two lateral sectors and the central sector are disposed on a surface of the collimation member that is situated above an optical axis of the optical component.

5. The module as claimed in claim 3, wherein the second portion includes the central sector.

6. The module as claimed in claim 1, wherein the collimation member includes a complementary sector configured to reflect a third part of the light rays toward the entire crest line.

7. The module as claimed in claim 1, wherein the entrance dioptric interface includes a central portion configured to transmit light rays toward the second zone of the crest line.

8. The module as claimed in claim 1, wherein, in a direction of the optical axis of the optical component, the distance separating the folder and the exit dioptric interface is equal to the focal distance of the exit dioptric interface.

9. The module as claimed in claim 1, wherein the inflection point is situated on the optical axis of the optical component.

10. The module as claimed in claim 1, wherein at least one of the two cutoff lines is curvilinear.

11. The luminous module as claimed in claim 1, wherein the light source is configured to emit the light rays along the optical axis of the optical component, the entrance dioptric interface, the collimation member and the exit dioptric interface being aligned along the optical axis.

12. The luminous module as claimed in claim 1, wherein the light source is configured to emit the light rays along an axis transverse to the optical axis of the optical component, the entrance dioptric interface and the collimation member being disposed along the transverse axis, and the optical component having a reflective surface disposed between the collimation member and the folder and configured to receive the light rays that are reflected by the collimation member and to reflect them along the optical axis of the optical component toward the folder.

13. A luminous device comprising a plurality of modules, with at least some of the modules of the plurality of modules include a light source capable of emitting light rays, and a single-piece optical component having an entrance dioptric interface intended to receive light rays from the light source, a collimation member configured to produce a reflection, within the optical component, of light rays that are received by the entrance dioptric interface, a folder including a crest line having two cutoff lines that join at an inflection point, and an exit dioptric interface through which the beam is projected, wherein the collimation member includes a first portion configured to reflect a first part of the light rays toward a first zone of the crest line that does not includes the inflection point, and a second portion configured to reflect a second part of the light rays toward a second zone of the crest line that is separate from the first zone and includes the inflection point.

14. The device as claimed in claim 13, wherein at least some of the modules of the plurality of modules are superposed.

15. The device as claimed in claim 14, wherein the superposed modules have an offset in a direction of the optical axis.

16. The device as claimed in claim 15, wherein the offset in the direction of the optical axis forms a rectilinear slope.
